(19) United States
(12) Patent Application Publication
(10) Pub. No.: US 2014/0014716 A1
(43) Pub. Date: Jan. 16, 2014

(54) Apparatus and Method for Providing Product Information

(71) Applicant: The Gillette Company, Boston, MA (US)

(72) Inventors: Jonathan Livingston Joyce, Independence, KY (US); Mathias Amann, Darmstadt Hessen (DE); Grant Edward Striemer, Hamilton, OH (US); Faiz Feisal Sherman, Mason, OH (US); Jose Tadeo Vergara DeCastro, Newton, MA (US); Jordan Todorov Bourilkov, Bethany, CT (US); Mark Wayne Morrow, Milford, OH (US); Steven Jeffrey Specht, Brookfield, CT (US)

(73) Assignee: The Gillette Company, Boston, MA (US)

(21) Appl. No.: 14/025,858

(22) Filed: Sep. 13, 2013

Related U.S. Application Data
(63) Continuation-in-part of application No. 13/616,343, filed on Sep. 14, 2012.
(60) Provisional application No. 61/580,379, filed on Dec. 27, 2011.

(51) Int. Cl. G06K 19/07; G06F 17/30; G06K 7/10

(52) U.S. Cl. CPC G06K 19/0723; G06K 7/10009; G06F 17/30
USPC 235/375; 235/492; 235/439

(57) ABSTRACT

A sensor system comprises a tag. The tag comprises at least one sensor, an analog to digital converter, a passive radio-frequency chip, and a first antenna. The sensor is adapted to provide an output analogous to a change in an environment of the sensor. The sensor produces an analog output and includes output terminals. The analog to digital converter is adapted to convert an analog output of the sensor to a digital value. The analog to digital converter includes input and output terminals. The input terminals of the analog to digital converter are disposed in electrical communication with the output terminals of the sensor. The passive radio-frequency chip comprises a memory element, input terminals and output terminals. The input terminals are disposed in electrical communication with the output terminals of the analog to digital converter. The first antenna is disposed in electrical communication with the output terminals of the chip.

### FIELD OF THE INVENTION

The invention relates to systems and methods for determining information about a product. The invention relates particularly to the remote interrogation of product information and the subsequent use of the acquired information.

### BACKGROUND OF THE INVENTION

Consumable goods having a useful life defined in terms of the consumption of the goods are well known. The useful life may be viewed as one or more events associated with the consumption of at least a portion of the useful quantity of the goods. Information associated with the environment of use of the goods and/or the quantity of goods used and remaining available may exist but may also be generally inaccessible to the typical consumer of the goods. What is needed is a system and method for extracting product relevant information in a manner which makes the information readily accessible and usable by the consumer.

### SUMMARY OF THE INVENTION

In one aspect, a sensor system comprises a tag. The tag comprises an analog to digital converter, a radio-frequency chip, a first antenna, and includes, or attaches to, at least one sensor. The chip may be an active or passive chip. The sensor is adapted to provide an output analogous to a change in an environment of the sensor. The sensor produces an analog output and includes output terminals. The analog to digital converter is adapted to convert an analog output of the sensor to a digital value. The analog to digital converter includes input and output terminals. The input terminals of the analog to digital converter are disposed in electrical communication with the output terminals of the sensor. The passive radio-frequency chip comprises a memory element, input terminals and output terminals. The input terminals are disposed in electrical communication with the output terminals of the analog to digital converter. The first antenna is disposed in electrical communication with the output terminals of the chip.

In one aspect a method of determining product information includes the steps of: providing a product comprising a tag, and an interrogator adapted to detect radiation associated with the data of the tag; interrogating the state of the tag; interpreting the state of the tag; and providing an output associated with the interpreted state of the tag. The tag comprises a digital memory storing data associated with the product.

### BRIEF DESCRIPTION OF THE DRAWINGS

Further features and benefits of the present invention will become more readily apparent through consideration of the drawings.

FIG. 1 shows a schematic representation of one embodiment of the invention.

FIG. 2 show s a schematic representation of one embodiment of the invention.

FIG. 3 shows a schematic representation of one embodiment of the invention.

### DETAILED DESCRIPTION OF THE INVENTION

### Definitions

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

In one aspect, a sensor system comprising a tag. The tag may comprise one or more layers of conductive inks, and non-conductive materials printed upon a substrate. Exemplary substrate materials include: polymer films, paper, high permittivity dielectric materials, and FR-4 material. Multiple layer structures may further comprise partial layers of non-conducting material separating at least portions of the conductive layers. Exemplary conductive layers include copper and silver inks. The tag comprises at least an analog to digital converter (ADC), a radio-frequency chip, and a first antenna disposed as a circuit upon a card, coin, or inlay, and includes, or is coupled or attached to at least one sensor. Exemplary chip/first antenna combinations include model numbers: RI-I03-112A-03 (13.56 MHz), and RI-INL-R9QM (134.2 kHz), or model TRF7970A, each available from Texas Instruments, Dallas, Tex. The antenna may be in the physical form of a coil or a dipole. In one embodiment, the antenna may comprise a conductive package or product component to which the remainder of the tag is connected electrically. The chip/first antenna combination, and ADC (analog to digital converter) may be integrated into a unit tag available from IDS Microchip, Germany.

The sensor may be selected according to the nature of the environmental factor of interest. Typical sensor types include chemical sensors, electrical sensors, biological sensors, mechanical sensors, and physical sensors. The sensor of the tag may also comprise multiple sensor of a single type or a combination of sensors of differing types.

Exemplary chemical sensors include: model TGS 813 gas sensor for Propane, Butane, Methane, Alcohol, H2 made by Figaro Engineering Inc., and available from Conrad Electronics, of Wernberg-Köblitz, Germany. Exemplary electrical sensors include: model AH1751-PG-B-A Hall effect sensor to measure magnetic field made by Zetex Semiconductors, and available from Allied Electronics, of Fort Worth, Tex.

Exemplary mechanical sensors include: model L3G3200D 3-axis gyro based on MEMS made by ST Microelectronics, and model N11MA512023 strain gauge sensor made by Allied Electronic, Forth Worth, Tex.

Exemplary physical sensors include: model-VCNL4020 light sensor made by Vishay, and model LPS331AP pressure sensor based on MEMS made by ST Microelectronics.

Exemplary biological sensors can be tailored to detect various biological molecules such as diseases, ions, bio markers, antibodies, DNA, various proteins, metabolic markers etc. The method of detection fundamentally can be potentiometric or amperometric in nature. Analyzed material samples may be collected from an organism or from the environment and include: blood, epithelial cells, mucous, saliva, feces, hair, urine, air, water and other environmental materials. The electrode configuration can be two (working and counter) or three (working, counter and reference) where the electrodes can be made of a number of substrates such as gold, silver, platinum, carbon, etc. These electrodes may be purchased from Conductive Technologies, Inc., of York, Pa., or made (Sensors and Actuators B, 114, (2006) 357-363).

A potentiometric bio sensor that detects antibodies may take advantage of an ELISA sandwich assay. The previously mentioned electrodes are coated with a conductive polymer such as poly(pyrrole) to prepare a substrate suitable for bio attachment while maintaining conductivity to the electrode substrate. The materials for the assay may be purchased from Sigma-Aldrich, of St. Louis, Mo.: capture antibody-anti-mouse IgG (Fc specific) F(ab′)₂ fragment antibody produced in goat (M0284), antibody-mouse serum (M5905), analyte competitor-anti-mouse IgG (γ-chain specific) peroxidase antibody produced in goat (A3673) and albumin from bovine serum is used during the process to prevent non-specific binding (A7906).

The ELISA sandwich structure described from the bottom up on the working electrode, is as follows: capture antibody adsorption to the poly(pyrrole) substrate, analyte, analyte competitor with HRP conjugate, and working solution enzyme to catalyze the HRP to generate hydrogen peroxide. This reaction at the working electrode generates a potential with a resolution of micro volts.

To adapt the signal of the sensor to the ADC input range an integrated pre amplifier may be used. The needed power supply for the electrodes may be provided by the harvested energy of the RFID circuit because the needed current is in the micro ampere range. The harvested power may be stored with an element such as a capacitor for use by the sensor at a later time.

The sensor system may further comprise an interrogator. The interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation. The Bluetooth™ RFID Reader, model number 223012, available GAO RFID, of Toronto Canada, exemplifies one form of interrogator. The model 223012 interrogator has the capacity to interrogate the radio frequency tag and to determine the state of the memory of the tag and thus extract information associated with the output of the sensor or sensors relating to the environment of the tag. The 223012 further comprises a secondary network communications link utilizing the Bluetooth™ communications protocol for transmitting the information extracted from the tag to a secondary device or secondary interrogator, such as a Bluetooth™ enabled computer or smart phone. The secondary interrogator may further analyze the information relating to the state of the tag and/or the tags environment and provide an output associated with a particular tag and/or tag environment state. The interrogator may further comprise a display element such as an LCD or LED screen for displaying an output associated with the analyzed tag information. The interrogator may further comprise one or more sensors for ascertaining information associated with the environment of the interrogator. The sensors may include: temperature, humidity, acceleration sensors. The interrogator may further comprise one or more cameras enabling the capture of images associated with a product, the tag or the environment. The interrogator may comprise a Global Positioning capability enabling the interrogator to ascertain and share information relating to the geographic location of the interrogator.

In one aspect, the smart phone may serve as the only interrogator. In this aspect the smart phone may interrogate the tag thereby ascertaining the information from the memory of the tag. The interrogator may analyze or otherwise interpret the information and may create an output. The output may be provided to a system user via an audio output, visual output, haptic output or combinations thereof. The interrogator may utilize inputs from sensors or systems of the smart phone, including information and analysis available from a networked resource such as cloud computing resources, in addition to the tag information in creating the output. Exemplary smart phones suitably configured to perform as a system interrogator include: the Ace™ E320 Liquid Express, the Blackberry™ Bold™ 970, available from Research In Motion; the Casio IT-800; the Google Nexus 7™, available from Google, Inc. Mountain View Ca.; the HTC Desire C™, available from HTC of; the LG Optimus Elite; the Motorola Droid™ Razr™, available from Motorola; the Nokia 700; the Panasonic BizPad™; and the Samsung Galaxy S Advance™.

In one aspect, the sensor system may include a product. The term “product(s)” is used in the broadest sense and refers to any product, product group, services, communications, entertainment, environments, organizations, systems, tools, and the like. For example, an example of a product group is personal and household products, such as used by a person, family or household. Examples of a representative, and non-limiting list of product categories within the personal and household product group includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, laundry, oral care, paper products, personal cleansing, disposable absorbent articles, pet health and nutrition, prescription drugs, prestige fragrances, skin care, foods, snacks and beverages, special fabric care, shaving and other hair growth management products, small appliances, devices and batteries, services such as haircutting, beauty treatment, spa treatment, medical, dental, vision services, entertainment venues such as theaters, stadiums, as well as entertainment services such as film or movie shows, plays and sporting events A variety of product forms may fall within each of these product categories.

Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap.

Exemplary health care products include laxatives, fiber supplements, oral and topical analgesics, gastro-intestinal treatment products, respiratory and cough/cold products, heat delivery products, and water purification products. Exemplary paper products include toilet tissues, paper towels, and facial tissues. Exemplary hair care products include shampoos, conditioners (including rinse-off and leave-in forms), and styling aids. Exemplary household care products include sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, micro-dermabrasion and peel products, skin rejuvenation products, anti-aging products, masks, UV protection products, and skin care puffs, wipes, discs, clothes, sheets, implements and devices (with or without skin care compositions).

Other product groups include but are not limited to: sports equipment, entertainment (books, movies, music, etc), vision, and in-home-consumed medical and first aid, among others.

In one embodiment, the product may comprise a test unit for the evaluation of other products such as portable power sources. In this embodiment, the product may comprise all the described elements including the chip, antenna, and shielding. In using this embodiment, the user will place the power source of interest in the product and engage the tag of the unit using the interrogator. The interrogator will power the tag, read and analyze the memory value, and generate an output. The analysis will evaluate the read value in terms of the open circuit voltage of the power source to which it is analogous. The output may be in the form of a percentage of power remaining, a color coded output associated with the power remaining, a simple textual output, good or bad, etc., or combinations of these. The output may be further transmitted using a network communications link and/or displayed using the display element of the interrogator.

The tag may be attached to the packaging of the product such as the primary packaging of a liquid product, or a granular product. The tag may be immersed in or float upon the surface of a packaged liquid or granular product. The tag may be incorporated within the product such as within a disposable absorbent article such as within a diaper for the purpose of detecting an insult to the absorbent core of the diaper. The tag may be disposed upon the surface of the product itself such as upon the surface of a battery for the purpose of sensing information relating to the useful power remaining in the battery.

It is believed that conforming the antenna of the tag to the shape of the outer surface of the product yields a system where communication between the interrogator and the tag may be omni-directional or achievable at a variety of angles between the interrogator and the tag.

One of the problems associated with creating a communication device for various products is realized when the communication device is utilized on electromagnetically conductive bodies. Free space radio propagation principles do not apply near highly conductive bodies. Additionally, antenna performance is severely degraded when antennas are placed near metals. As such, simply placing an RFID tag on a battery or on an object with a conductive body may not accomplish the desired effect, e.g. energy harvesting and/or data transfer. Notably, this problem is not limited to rechargeable/disposable batteries. For example, a can of shaving gel, foam, etc., or a package comprising a metalized film, could experience the same issues because of the conductivity of the container. In general, an RFID tag next to metallic body decreases signal coupling between the reader and the tag by 10×.

One way to prevent the effects arising from metal proximity to the antenna is to prevent the electromagnetic field from entering the metal. For example, separating the antenna and the metal surface by placing a material with suitable electromagnetic properties and dimensions between them may divert the electromagnetic field around the metallic/conductive body of the product. The properties of the diverter material depend on the exact metal used and the RFID frequency. The magnetic diverter effectively isolates the tag from the can. An effective separation may also be achieved with an air filled gap between the materials.

In one aspect, a method of determining product information comprises steps of: providing a product comprising a tag as described above. The tag comprising, at least one sensor adapted to provide an output analogous to a change in an environment of the sensor. The sensor having at least one output terminal. The tag also comprising an analog to digital converter adapted to convert the analog output of the sensor to a digital value, the analog to digital converter having input and output terminals, the input terminal(s) of the analog to digital converter being disposed in electrical communication with the output terminal(s) of the sensor. The tag also includes a radio-frequency chip comprising a memory element, input terminals and output terminals, the input terminals disposed in electrical communication with the output terminals of the analog to digital converter, and a first antenna disposed in electrical communication with the output terminals of the chip.

The method also includes providing an interrogator adapted to detect radiation associated with the data of the tag. The interrogator may be an RF or NFC protocol reader coupled with a Bluetooth™ capability as described above, or a smart phone or other computing device comprising an RF or NFC capable reader.

The interrogator may be used to determine the current state of the tag utilizing an RF communications protocol such as the NFC protocol. The interrogator may interpret the data received from the tag using a software application written for that purpose. In one embodiment, the tag and sensor may be configured to detect an open circuit voltage of a battery cell. The detected open circuit voltage may alter the value of at least one bit of the memory of the tag. The interrogator may then read the value of the memory and correlate that value with an open circuit voltage and a useful battery life remaining. The useful battery life remaining may be displayed to a user of the system via a display element of the interrogator. The output displayed may be in terms of a percentage of life remaining or in more analog terms of red, yellow and green colors signifying little to no useful life, some useful life, or a significant amount of useful life depending upon the algorithm used to set the thresholds for converting the detected open circuit voltage to an analog of battery useful life. In one embodiment, the application may provide steps for the user of the application to input the nature of the load case of the battery. Exemplary load cases include powering: a flash camera, a toy, a flashlight, a remote control unit, a clock, or a radio or other entertainment system.

As an example, the tag may be incorporated as a sensor system for a 1.5 volt alkaline power source. In this example the sensor may be configured to read the open circuit voltage (OCV) in the range between 0.8 volts and 1.65 volts. The ADC may be designed to provide different digital output values in association with differing OCV values. As an example a 5 bit ADC may be used to partition the sensed voltage range of 0.85 volts across the 32 possible digital output values of the ADC. The analysis of the ADC output may be programmed to provide output changes at thresholds associated with OCV values considered of interest. AS an example, the output of the analysis may be programmed to switch at around a value associated with 1.25 volts, to switch a second time at around 1.35 volts. This example divides the OCV range into three zones, below around 1.25 volts, between 1.25 and 1.35 volts, and above 1.35 volts. These outputs may be further associated with a percentage equivalent or a color coding of red yellow and green respectively.

In one aspect, the interrogator may incorporate a secondary network communication module affording the device an ability to send and receive data over a cellular phone or other networks including a local area or WiFi networks. In such an aspect, the interrogator may transmit data received from the tag and/or an analysis of the data from the tag. The software application of the interrogator may analyze the data from the tag to determine if replenishment of the product associated with the tag in needed, or to project when such replenishment will be needed in view of usage history of the product established via a series of interrogations of the tag. In this aspect the application may be used to consummate a purchase of addition product via the network. The application may be further utilized to offer the user related products for purchase, or to make offers of other products not directly related to the product.

### Examples

A tag comprising a capacitive sensor strip coupled with an ADC may be arrayed within a package such as a mascara package, such that the sensor output will be analogous to the product quantity remaining within the package. An axis of the sensor may be aligned with the geometry of the package such that the portion of the sensor in contact with the product will change as the amount of product in the container changes. Upon interrogation, the tag sensor will provide an output to the ADC analogous to the product quantity remaining. The ADC will convert the output to a digital value and store that value in memory. The interrogator will read the stored value. The application software may then analyze the read value and interpret it in terms of the amount of product remaining. The software may then provide an output to the user indicating the amount of product remaining as a quantity or as a percentage of the original amount within the package. The software may be written to provide a suggestion to the user to replenish the product at a particular quantity or percentage threshold. The software may utilize the network communications capacity of the interrogator to enable the user to connect to a network retail source to purchase replenishment product offered by a network retailer. The software may search the network to identify a set of retailers and may also gather information such as the price and shipping options of the product associated with each retailer. The software may utilize a location provider by the user or derived via the GPS or WiFi location capabilities of the interrogator to identify retailers having location near the present location of the user where the product may be directly purchased.

A tag comprising an electrical sensor, such as a sensor for resistance, capacitance, inductance, or combinations thereof, may be provided in contact with a product as part of a product/package combination. The system may be configured to sense changes in the product, such as changes related to shelf stability or the efficacy of the product, and to provide an output associated with such a change in the product.

A tag comprising a temperature sensor may be incorporated within the diaper such that upon interrogation the sensor output to the ADC will be analogous to the temperature of the wearer of the diaper which will be stored digitally in the memory of the tag. The application software may read the stored value and interpret it in terms of body temperature. The associated value may be stored by the application software together with other available data such as date, time, location, images of the wearer, and combinations thereof. A collection of data records may be accumulated over time and used as an indicator of the wearer's health and wellness.

A tag comprising a chemical or biosensor coupled to an ADC may be incorporated within a patient garment for the purpose of detecting environmental factors associated with the occurrence of pressure ulcers. Other tags having chemical or biological sensors may be used for purposes such as detecting metabolic markers in saliva, detecting alcohol in breath or saliva, detecting malodorous compounds in air samples.

In one embodiment, the system tag may be subdivided into portions. One portion may contain the antenna, the ADC and the chip, the other portion may contain the sensor. The two portions of the tag may be disposed with the sensor exposed to the functional environment of an absorbent article, and the antenna, ADC, chip portion removed from exposure to the functional environment of the article. The antenna, ADC, chip portion may be made removable and therefore reusable as well. In one embodiment, conductive hook and loop fasteners, such as are available from APLIX Inc., of Charlotte, N.C., may be used to create an interface between the functional environment of the article and the exterior of the article. The attachment mechanism between the article, sensor and the removable tag to enable conductivity can be hook & loop, compression (e.g. elastic band, garter), adhesion (e.g. adhesive strip), magnetic, or combinations thereof. In this embodiment, the sensor may be fabricated as an assembly in electrical contact with the conductive hook and loop pads which in turn are disposed upon an exterior surface of the article. Matching pads may be incorporated as part of the assembly of the antenna, ADC, chip assembly and the two respective assemblies may be united using the matching hook and loop pads for operational use of the tag. In this manner, the more costly antenna, ADC, chip assembly may be rendered reusable thereby reducing the overall cost associated with using the system with a number of respective disposable articles. The respective assemblies may be formed using conductive adhesive, such as is available from MG Chemicals, of Surrey, B.C., Canada to affix the electrical leads of the respective portions of the tags to their respective hook and loop fastener pads.

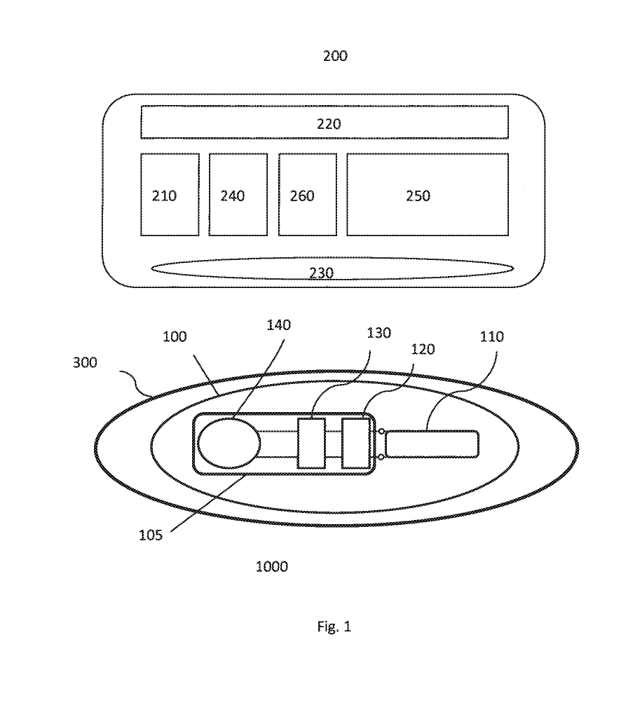

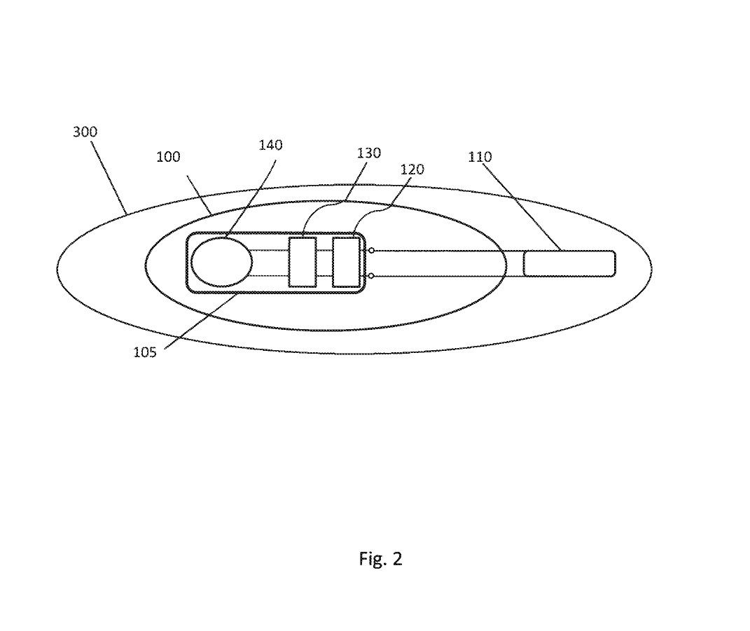

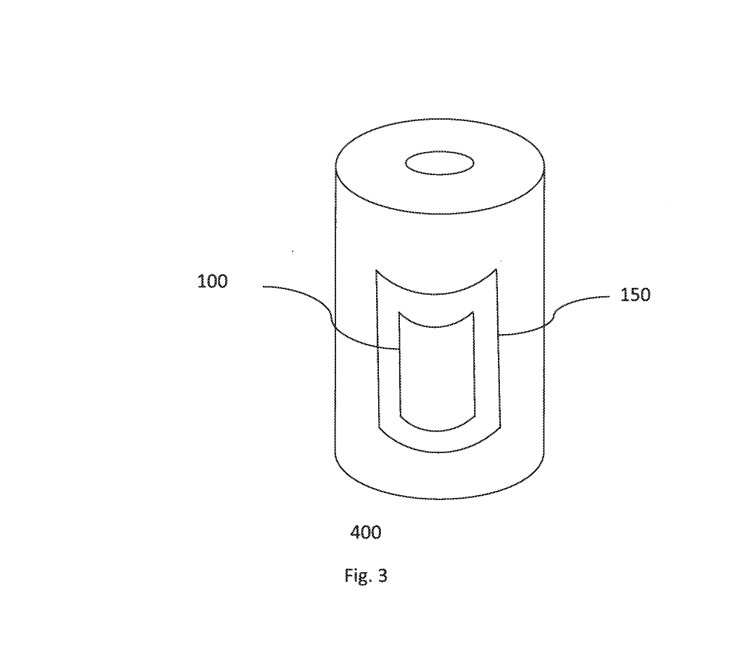

As shown in FIG. 1, a system 1000, comprises an absorbent article 300, and an interrogator 200. The absorbent article 300 comprises a tag 100. The tag 100 comprises a sensor 110, and a removable portion 105 including an analog to digital converter, 120, a chip 130, and an antenna 140. The interrogator 200 comprises a sensor 210, a power source 220, an antenna 230, an analysis element 240, a display element 250, and a network link 260. As shown in FIG. 2, an absorbent article 300 comprises a tag 100 and a sensor 110. The tag 100 comprises a removable portion 105 including an analog to digital converter 120, a chip 130, and an antenna 140. As shown in FIG. 3, a portable power source 400, comprises a tag 100 and shielding 150.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensor system comprising a tag, the tag comprising:
a first portion including
a. at least one sensor adapted to provide an output analogous to a change in an environment of the sensor, the sensor having output terminals;
and a second portion, the second portion including:
b. an analog to digital converter adapted to convert the analog output of the sensor to a digital value, the analog to digital converter having input and output terminals, the input terminals of the analog to digital converter being disposed in electrical communication with the output terminals of the sensor;
c. a radio-frequency chip comprising a memory element, input terminals and output terminals, the input terminals disposed in electrical communication with the output terminals of the analog to digital converter;
d. a first antenna disposed in electrical communication with the output terminals of the chip
wherein the first portion and second portion are releasably connected one to the other.

2. The sensor system according to claim 1 further comprising: an interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation.

3. The sensor system according to claim 2 wherein the interrogator further comprises: an analysis element adapted to interpret the extracted embedded data, and a display element adapted to display the results of the interpretation.

4. The sensor system according to claim 2 wherein the interrogator further comprises a sensor.

5. The sensor system according to claim 2 wherein the interrogator further comprises a network communications link.

6. The sensor system according to claim 1 wherein the sensor is selected from the group consisting of: chemical sensors, electrical sensors, biological sensors, mechanical sensors, physical sensors and combinations thereof.

7. The sensor system according to claim 1 wherein the first antenna comprises an omni-directional antenna.

8. The sensor system according to claim 1 further comprising a product wherein the tag comprises part of the product.

9. The sensor system according to claim 1 wherein the product comprises a disposable absorbent article.

10. The sensor system according to claim 1 wherein the product comprises a portable power source.

11. The sensor system according to claim 1 wherein the product comprises a package containing a consumable good.

12. The sensor system according to claim 8 further comprising electrical shielding disposed between the antenna and product.

13. The sensor system according to claim 12 wherein the shielding comprises part of the tag.

14. The sensor system according to claim 1 wherein the antenna comprises a coil.

15. The sensor system according to claim 1 wherein the antenna comprises a dipole.

16. A method of determining product information, the method comprising steps of:
a. providing a product comprising a tag, the tag comprising: a first portion including at least one sensor adapted to provide an output analogous to a change in an environment of the sensor, the sensor having output terminals; a second portion including: an analog to digital converter adapted to convert the analog output of the sensor to a digital value, the analog to digital converter having input and output terminals, the input terminals of the analog to digital converter being disposed in electrical communication with the output terminals of the sensor; a radio-frequency chip comprising a memory element, input terminals and output terminals, the input terminals disposed in electrical communication with the output terminals of the analog to digital converter; a first antenna disposed in electrical communication with the output terminals of the chip;
b. providing an interrogator adapted to detect radiation associated with the data of the tag;
c. interrogating the state of the tag;
d. interpreting the state of the tag;
e. providing an output associated with the interpreted state of the tag.

17. The method according to claim 16 wherein the step of providing an interrogator further comprises providing an interrogator comprising a network communications link, the method further comprising a step of sharing the interpreted state of the tag over a network.

18. The method according to claim 17 further comprising the step of sharing data from the interrogator sensor over the network.

19. The method according to claim 17 further comprising the step of purchasing a unit of the product using the network.

20. The method according to claim 16 wherein the step of providing an output associated with the interpreted state of the tag comprises displaying a result associated with the interpreted state of the tag.
